(19) United States
(12) Patent Application Publication
(10) Pub. No.: US 2022/0221248 A1
(43) Pub. Date: Jul. 14, 2022

(54) ADAPTER FOR FASTENING AN ATTACHMENT TO A TELESCOPIC SIGHT

(71) Applicant: EP Arms GmbH, Roethenbach an der Pegnitz (DE)

(72) Inventor: Philipp Engelbreit, Lauf an der Pegnitz (DE)

(21) Appl. No.: 17/572,869

(22) Filed: Jan. 11, 2022

(30) Foreign Application Priority Data
Jan. 11, 2021 (DE) 10 2021 200 186.6

(51) Int. Cl. F41G 1/38; F16B 2/06

(52) U.S. Cl. CPC F41G 1/38; F16B 2/06

(57) ABSTRACT

An adapter for fastening an attachment to a telescopic sight has a clamping ring, which can be fastened to the telescopic sight. The clamping ring has a retaining contour for releasable, form-fitting and/or force-fitting fastening to a mating contour, which is arranged or can be arranged on the attachment.

### CROSS-REFERENCE TO RELATED APPLICATION

This application claims the priority, under 35 U.S.C. § 119, of German Patent Application DE 10 2021 200 186.6, filed Jan. 11, 2021; the prior application is herewith incorporated by reference in its entirety.

### FIELD AND BACKGROUND OF THE INVENTION

The invention relates to an adapter for fastening an attachment to a telescopic sight.

A telescopic sight is a long-range optical device, which can be mounted as a primary sight, for example on a firearm. Such a telescopic sight serves to optically magnify objects viewed through it at a distance. For this purpose, the telescopic sight has a tube with an objective lens on the object side and with an eyepiece on the user or eye side. An optical channel is formed between the objective and the eyepiece, in which, for example, a plurality of optical, in particular optically magnifying, elements, for example lenses and/or prisms, are arranged. The optical channel typically also contains a reticle, i.e., a target marking.

In order to enable reliable aiming in limited or poor light conditions, so-called attachment or set top devices are used, for example in the form of night vision devices or thermal imaging devices, which are arranged in front of the objective of the telescopic sight. In such an attachment, the telescopic sight is aimed at an image produced by the attachment. In other words, the reticle is aimed at an image. As a result, it is necessary for such an attachment to be arranged in alignment with the telescopic sight as far as possible. This means that the optical axes or channels of the telescopic sight and the attachment should be aligned with each other with as little misalignment as possible.

Typically, the attachment and the telescopic sight or respectively the objective do not touch each other. The background to this is that the attachment has a comparatively high construction weight, for example between 300 g (grams) and 800 g, and is subjected to a strong load by the upward impact when the firearm is fired. In particular, a constant, firm fixation of the attachment is desired, so that no misalignment between the optical axes occurs after a shot is fired.

The attachment can be mounted in front of the telescopic sight, for example, by means of a mounting rail. The mounting rail is typically fastened to the firearm.

Equally conceivable is, for example, the use of adapters as mounting adapters, which are arranged as a mechanical interface between the telescopic sight and the attachment. For example, adapters designed as clamping rings with a quick-release fastener or quick-release clamp are possible, which on the one hand can be clamped to a tube end of the telescopic sight on the objective side and to the attachment on the other hand. The attachment is thus indirectly fastened to the telescopic sight via the adapter and is thus carried by the telescopic sight.

### SUMMARY OF THE INVENTION

It is accordingly an object of the invention to provide an adapter which overcomes the above-mentioned disadvantages of the heretofore-known devices and methods of this general type and which provides for particularly suitable adapter for fastening an optical attachment to a telescopic sight, such as a rifle scope. In particular, the object is to enable the fixing or mounting of the attachment to the center of the scope (i.e., optical axis) to be as repeatable as possible.

With the above and other objects in view there is provided, in accordance with the invention, an adapter for fastening an attachment to a telescopic sight, the adapter comprising:

a clamping ring to be fastened to the telescopic sight;

the clamping ring having a retaining contour configured for releasably fastening, with at least one of a form-fit or a force-fit, to a mating contour arranged on, or formed on, the attachment.

The adapter according to the invention is provided for fastening an attachment to a telescope, and is thus configured for that purpose. The telescopic sight is preferably a rifle scope fastened or mounted to a firearm, in particular a hand-held firearm such as a hunting rifle. By way of example, the attachment or mounted device is configured as a thermal imaging or night vision device.

In this case, the adapter has a clamping ring, which is fastened or can be fastened to the telescopic sight, wherein the clamping ring has a retaining contour for releasable form- and/or force-fitting fastening, locking, latching or interlocking with a mating contour, which is arranged or can be arranged on the attachment.

The conjunction “and/or” here and in the following is to be understood in such a way that the characteristics linked by means of this conjunction can be formed both together or as alternatives to each other. The expression “at least one of A or B” is to be understood as either A alone, or B alone, or A and B together.

“Form fit” or a “form-fitting connection” between at least two interconnected parts here and in the following is understood in particular to mean that the cohesion of the interconnected parts takes place at least in one direction by a direct interlocking of contours of the parts themselves or by an indirect interlocking via an additional connecting part. The “blocking” of a mutual movement in this direction thus takes place due to the shape. The term “form fit” is synonymous with “positive fit.”

“Force-fitting connection” between at least two connected parts here and in the following is understood to mean in particular that the connected parts are prevented from sliding against each other due to a frictional force acting between them. If a “connecting force” causing this frictional force is missing (this means the force that presses the parts against each other, for example a screw force or the weight force itself), the force-fitting connection cannot be maintained and can therefore be released. The term “force fit” is synonymous with “friction fit.”

The adapter thus enables non-destructive and repeatable fastening of the attachment to the telescopic sight. In particular, it is possible to arrange the optical axes of the telescopic sight and the attachment in a reproducible manner with as little misalignment as possible. In other words, the adapter enables the field of view of the attachment to be precisely aligned with the center of the field of view of the telescopic sight with repeat accuracy, so that an optimum observation position is always realized. Thus, a particularly suitable adapter is realized.

The retaining contour and mating contour can be designed—without limiting the generality—for example as a threaded connection, a bayonet connection, or as a sword lock. It is essential that a non-destructively releasable, form-fitting and/or force-fitting joint connection can be realized.

“Axial” or an “axial direction” here and in the following is understood to mean in particular a direction parallel (coaxial) to the optical axis or along a longitudinal direction of the telescopic sight, i.e. perpendicular to the end faces of the approximately cylindrical tube. Accordingly, here and in the following, “radial” or a “radial direction” is understood to mean in particular a direction oriented perpendicularly (transversely) to the optical axis of the telescopic sight along a radius of the telescopic sight or tube. “Tangential” or a “tangential direction” here and in the following is understood in particular to mean a direction along the circumference of the telescopic sight or tube (circumferential direction, azimuthal direction), i.e. a direction perpendicular to the axial direction and to the radial direction.

In this case, the adapter can be designed, for example, as a special mounting adapter, the retaining contour of which is adapted to a predetermined mating contour of the attachment device. In a suitable embodiment, however, the adapter has a retaining ring, which can be fastened to the attachment device and is provided with the mating contour. In this case, the retaining ring can be manufactured for a wide variety of attachment devices. In this case, the retaining ring is adapted to a respective locking type of the attachment device. For example, the retaining ring has a thread diameter adapted to a fastening thread of the attachment device. As a result, it is possible to retrofit the attachment device by means of the retaining ring for attachment to the clamping ring. The retaining ring thus acts as a quasi-adapter ring for the adapter. In particular, it is thus possible to mount the attachment device on a wide variety of telescopic sights without changing or exchanging the retaining ring, wherein re-shooting is not necessary.

In a conceivable further development, the clamping ring has two ring halves or half-shells, which can be braced against each other in a clamp-like manner. In this case, the ring halves embrace a tube end of the telescopic sight on the objective side, which is clamped tangentially and radially by the clamping ring in a form-fit and force-fit manner in the clamped or mounted state. This enables a simple and non-destructively detachable attachment of the clamping ring to the telescopic sight.

In a conceivable embodiment, the ring halves can be braced against each other, for example, by means of two approximately diametrically opposed fastening screws. For example, the ring halves each have two diametrically opposite flange areas with a (threaded) bore, wherein the flange areas of the ring halves are arranged in alignment with each other. In this way, a simple and effort-reduced clamping attachment to the telescopic sight is realized.

The clamping ring is thus mounted on the telescopic sight by means of two fastening screws via a surface pressure of the ring halves. This also allows the clamping ring to be easily adapted to telescopic sights with different (tube) diameters. In a particularly advantageous embodiment, the ring halves or respectively the surface pressure have a clamping or contact surface with an axial width of less than 20 mm (millimeters), in particular less than 17 mm, preferably about 15 mm. In other words, for example, only a clamping surface with a width of 15 mm is required. This has the consequence that likewise combined weapons such as a triplet or a over and under shotgun can be used with an attachment.

In an additional or further aspect of the invention, the retaining contour and the mating contour are configured as a threaded connection. For example, in this case, the retaining contour is configured as an external thread and the mating contour is configured as a corresponding internal thread.

Preferably, the retaining contour and the mating contour are designed in such a way that they can be joined together by means of a rotary movement, in particular by means of a 45° rotary movement, of the mating contour or respectively the retaining ring. For this purpose, in a preferred embodiment, the retaining contour and the mating contour are designed as interrupted round threads. Suitably, a fine centering is provided in this case, for example on the clamping ring, which intercepts a surface in the thread play as a fitting diameter, so that a repeat accuracy of, for example, ±0.05 mm is ensured by the flat contact of the contours and the fine centering.

In an expedient further development, the adapter has an adjustable locking element, for example an actuable locking pin, which blocks a relative movement of the contours. The locking pin is here arranged, for example, on the clamping ring and/or on the retaining ring. In a design of the contours as interrupted round threads, the locking pin engages here, for example, in an intermediate space formed by the interruptions. This ensures a constant and unchanged positioning (rotation) at all times when the attachment device is fastened to the clamping ring. For example, the retaining ring has a locking pin, which is unlocked by pressing a lever.

In an alternative embodiment, the retaining contour and the mating contour are designed in the manner of a bayonet connection. In a conceivable embodiment, the retaining contour is designed as two protruding pins, which are directed radially inwards at diametrically opposite points on the clamping ring, and the mating contour is designed as two radial inclined grooves. Thus, a particularly short design of the adapter is realized.

Other features which are considered as characteristic for the invention are set forth in the appended claims.

Although the invention is illustrated and described herein as embodied in adapter for fastening an attachment to a telescopic sight, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a perspective view of a forward portion of a telescopic sight with an adapter with a retaining ring and with a clamping ring;

FIG. 2 and FIG. 3 are perspective views of a second exemplary embodiment of an adapter according to the invention;

FIG. 4 is a partial sectional view of the adapter according to the second embodiment; and

FIG. 5 and FIG. 6 are perspective views of a third exemplary embodiment of the adapter.

Corresponding parts and dimensions are marked with the same reference signs throughout the figures.

### DETAILED DESCRIPTION OF THE INVENTION

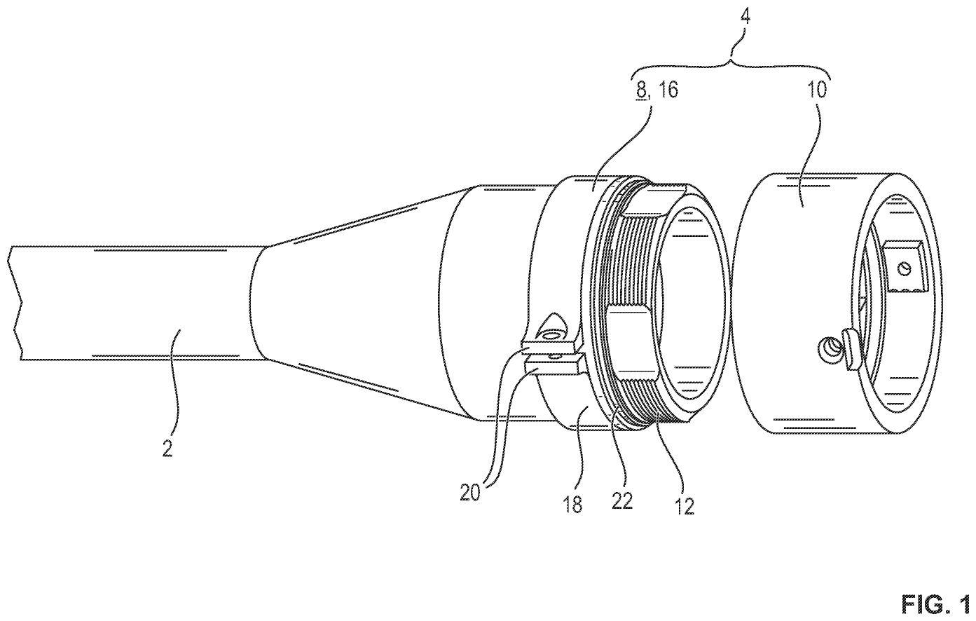

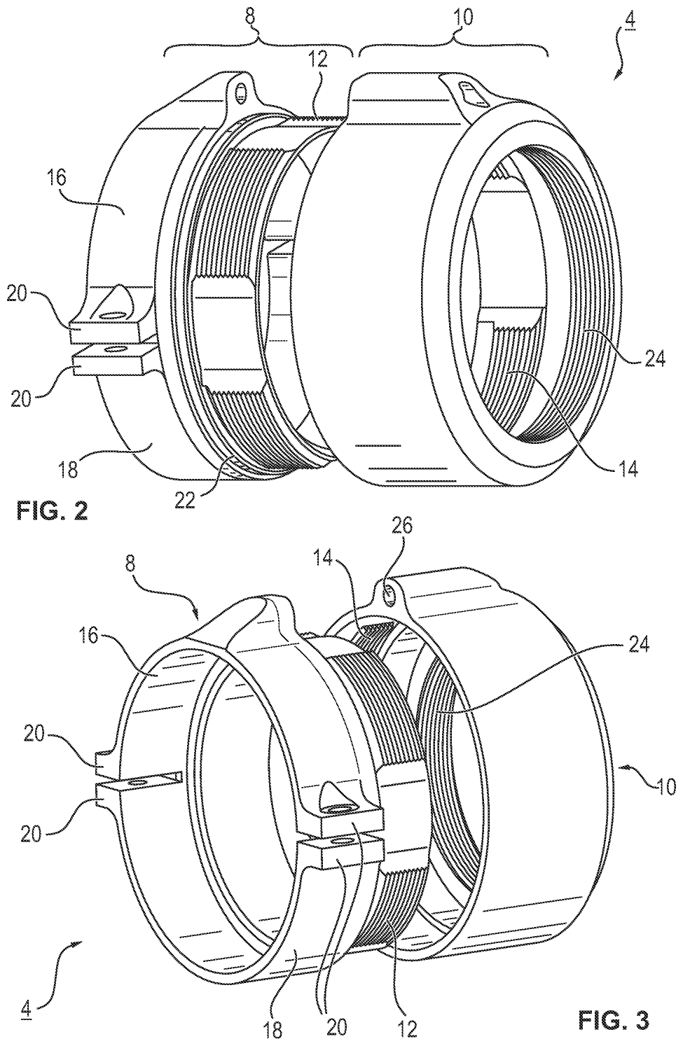

Referring now to the figures of the drawing in detail and first, in particular, to FIG. 1 thereof, there is shown a portion of a telescopic sight, i.e., a rifle scope 2 with an adapter 4 for fastening an attachment 6 (the attachment 6 is illustrated in FIG. 6). The adapter 4 has a clamping ring 8 fastened to the objective side of the telescopic sight 2, which can be mechanically coupled to a separate retaining ring 10. For this purpose, the clamping ring 8 has a retaining contour 12 and the retaining ring 10 has a corresponding mating contour 14 (FIG. 2).

In the exemplary embodiment of FIG. 1, the contours 12, 14 are designed as threads, so that the mechanical coupling between the adapter parts 8, 10 is implemented in particular as a form-fitting and/or force-fitting threaded connection.

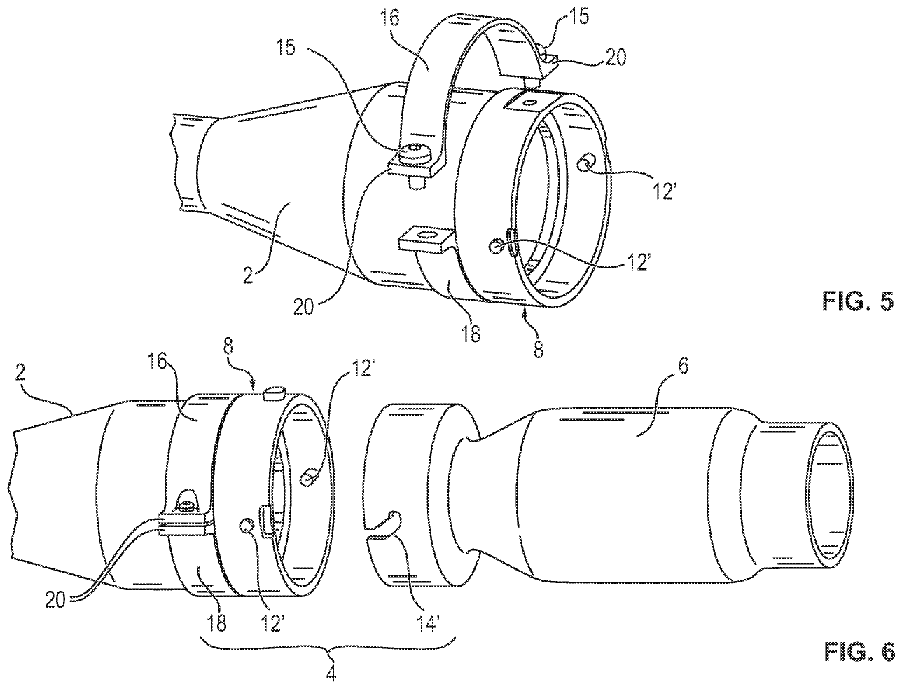

The clamping ring 8 has two ring halves 16, 18, which can be braced against each other by clamping. The ring half 18 is made in one piece, i.e. monolithic, with the retaining contour 12. The ring halves 16, 18 in this case embrace the objective-side tube end of the telescopic sight 2, which in the braced or mounted state is clamped tangentially and radially by the clamping ring 8 in a form-fitting and force-fitting manner. In this regard, a form-fit may also be referred to as a positive fit and a force-fit may also be referred to as a friction fit. The ring halves 16, 18 can be braced against one another in this case by means of two diametrically opposite fastening screws 15 (FIG. 5). The ring halves 16, 18 each have two diametrically opposite flange areas 20 with a (threaded) bore.

In this case, the ring halves 16, 18 or respectively the surface pressure of the clamping ring 8 have a clamping or contact surface with an axial width of less than 20 mm, in particular less than 17 mm, preferably about 15 mm.

Preferably, the retaining contour 12 is designed as an external thread of the clam-ping ring 8 and the mating contour 14 is designed as a corresponding internal thread of the retaining ring 10. Preferably, the contours or threads 12, 14 are designed in such a way that they can be joined to each other by means of a rotary movement, in particular by means of a 45° rotary movement, of the mating contour 12 and of the retaining ring 10, respectively. For this purpose, the contours 12, 14 are designed as interrupted round threads. Suitably, a fine centering 22 is provided on the clamping ring 8, which intercepts a surface in the thread play as a fitting diameter, so that a repeat accuracy of, for example, ±0.05 mm is ensured by the flat contact of the contours and the fine centering.

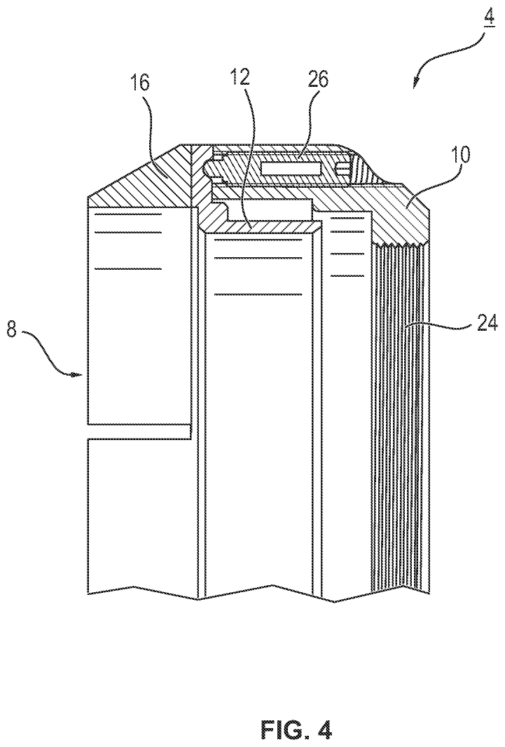

In the following, with reference to FIGS. 2 to 4, a second embodiment of the adapter 4 is explained in more detail. In this embodiment, the adapter 4 is designed in particular as a mounting adapter, which has a retaining ring 10 adjusted to a special attachment. In this case, the retaining ring 10 is provided with an internal thread 24, which can be screwed into a corresponding external thread of the attachment device.

The adapter 4 of FIGS. 2 to 4 further has an adjustable locking element 26, by means of which the fastening or locking, i.e. the rotational position of the adapter parts 8, 10 in the assembly position, can be fixed. In this embodiment, the locking element 26 is formed as a spring pressure piece, which is integrated in the retaining ring 10.

FIGS. 5 and 6 show a third embodiment of the adapter 4. In this embodiment, the mating contour 14′ is designed as a part of the attachment device 6. For this purpose, the mechanical coupling or joining connection of the adapter 4 is designed in the manner of a bayonet connection. For this purpose, the clamping ring 8 has two pins projecting radially inwards on the inner circumference as a retaining contour 12 ‘, wherein the mating contour 14’ is designed as two radial inclined grooves of the attachment device 6.

It will be understood that the invention is not limited to the embodiments described above. Rather, other variants of the invention may also be derived therefrom by the expert without leaving the object of the invention. Furthermore, in particular, all individual features described in connection with the embodiment examples can also be combined with each other in other ways without leaving the object of the invention.

The following is a summary list of reference numerals and the corresponding structure used in the above description of the invention:
2 telescopic sight, rifle scope
4 adapter, adapter device
6 attachment
8 clamping ring
10 retaining ring
12, 12′ retaining contour
14, 14′ mating contour
15 fastening screws
16 ring half
18 ring half
20 flange area
22 fine centering
24 internal thread
26 locking element

1. An adapter for fastening an attachment to a telescopic sight, the adapter comprising:
a clamping ring to be fastened to the telescopic sight;
said clamping ring having a retaining contour configured for releasably fastening, with at least one of a form-fit or a force-fit, to a mating contour arranged on, or formed on, the attachment.

2. The adapter according to claim 1, further comprising a retaining ring to be attached to said attachment, said retaining ring having said mating contour.

3. The adapter according to claim 1, wherein said clamping ring comprises two ring halves to be braced against one another to form a clamp.

4. The adapter according to claim 3, wherein said ring halves can be braced against one another by way of two diametrically opposite fastening screws.

5. The adapter according to claim 3, wherein said ring halves have a clamping surface for retaining said ring halves on the telescopic sight with an axial width of less than 20 mm.

6. The adapter according to claim 5, wherein said axial width is approximately 15 mm.

7. The adapter according to claim 1, wherein said retaining contour is an external thread and said mating contour is a corresponding internal thread.

8. The adapter according to claim 7, wherein said external thread and said internal thread are interrupted round threads.

9. The adapter according to claim 1, wherein at least one of said retaining ring or said clamping ring has an adjustable locking element.

10. The adapter according to claim 1, wherein said retaining contour and said mating contour together form a bayonet connection.

11. The adapter according to claim 10, wherein:
said retaining contour comprises two pins, which are directed radially inwards at diametrically opposite points of said clamping ring; and
said mating contour is formed with two radial, inclined grooves.
